(19) United States
(12) Patent Application Publication
(10) Pub. No.: US 2010/0139036 A1
(43) Pub. Date: Jun. 10, 2010

(54) CLOSING SYSTEM FOR REFRIGERATING CABINETS

(75) Inventor: Rossi Romolo, Bastia Umbra (IT)

Correspondence Address: YOUNG & THOMPSON, 209 Madison Street, Suite 500, Alexandria, VA, 22314, US

(73) Assignee: INDUSTRIE SCAFFALATURE ARREDAMENTI ISA S.P.A., Bastia Umbra (IT)

(21) Appl. No.: 12/294,045

(22) PCT Filed: Feb. 22, 2008
(86) PCT No.: PCT/IT2008/000122

§ 371 Date: Sep. 23, 2008

(30) Foreign Application Priority Data
Oct. 17, 2007 (IT) RM2007A000544

(51) Int. Cl. E05F 1/00

(52) U.S. Cl. 16/71

(57) ABSTRACT

A closing system (1) for refrigeration cabinets comprises a plurality of panels (5) mutually connected telescopically and slidable between an open position, whereat the panels (5) are completely superposed, facing each other and aligned along an orthogonal direction (s) to a plane (X) of lay of the panels (5), and a closed position, whereat the panels are arranged along a direction (t) parallel to the plane (X) of lay of the panels, offset along an orthogonal direction to said plane (X); at least one element (14) supporting and guiding said panels (5) and at least one device (9) for actuating said panels (5). A closing system (1) can be coupled to each refrigerated compartment (3) constituting the refrigerating cabinet (2), to close, in reversible, access to the products contained within the compartment (3) and to minimise its thermal dispersion to the environment.

### TECHNICAL FIELD

The present invention relates to a closing system for refrigerating cabinets.

In particular, the present invention is applicable to the individual containment compartments of the refrigerating cabinets containing refrigerated or frozen food products.

### BACKGROUND ART

As is well known, in food stores some products are exposed on shelves or inside refrigerating cabinets.

Generally, frozen products are contained in compartments with tanks or shelves, the latter always closed by sealing doors which the user opens when it is required to do so; refrigerating cabinets for refrigerated products can also be tank shaped or with shelves, but they are generally always open, with consequent high energy consumption. To reduce energy consumption, in some stores the refrigerated compartments are also provided with closing systems, active at least during non-working hours.

Closing systems, i.e. systems that introduce a more or less continuous and sizeable barrier on the ideal surface that constitutes the opening of the cabinet to the environment, with the goal of reducing thermal dispersions and improve the preservation of the product, can be classified in two types: night-time closings and day-time closings.

Night-time closing systems are very effective from the thermal point of view, are completely covering and are applied manually, often in inconvenient fashion for service personnel, or in motorised fashion, with actuation times of some tens of seconds.

Once they are removed, these closing systems have to be removed from the cabinet or anyway they cannot remain in view because they would hamper accessibility to the products, as well as being aesthetically displeasing.

Day-time closing systems, instead, are used during sales hours, but they can easily be used also during off hours, alternatively to or with the aid of night-time closing systems. Generally, these systems are see-through, to allow buyers to view the product. They are less effective from the thermal viewpoint than night-time closing systems and they are removed manually by final users to access the product to be withdrawn.

Once removed, these systems remain visible near the compartment, oftentimes also in positions that hinder access to neighbouring compartment and/or that limit the physical approach to the cabinet.

Currently, there is to solution that combines the advantages of day-time closing, i.e. the good visibility of the product and the possibility of a continuous access to the compartment, with those of night-time closing, i.e. to remain out of sight and not to hinder accessibility to the product and to the cabinet when they are open.

An object of the present invention is to solve the problems encountered in the prior art, proposing a closing system for refrigerating cabinets that is able to overcome the aforementioned drawbacks.

In particular, an object of the present invention is to provide a closing system for refrigerating cabinets that allows good visibility and accessibility to the products contained in the different compartments, without hindering access to neighbouring compartments during the opening and/or closing phases.

Therefore, an object of the present invention is to propose a closing system for refrigerating cabinets that has reduced size but still enables to reduce energy consumption.

Another object of the present invention is to propose a system for closing refrigerating cabinets that is modular and adaptable according to the requirements of space and arrangement of each refrigerating cabinet.

### DISCLOSURE OF THE INVENTION

These objects and others as well, which shall become more readily apparent in the course of the following description, are substantially achieved by a closing system for refrigerating cabinets comprising the characteristics expressed in one or more of the appended claims.

Further characteristics and advantages shall become more readily apparent from the detailed description of a preferred, but not exclusive, embodiment of a closing system for refrigerating cabinets in accordance with the present invention. Said description shall be provided below with reference to the accompanying figures, provided purely by way of non limiting indication, in which:

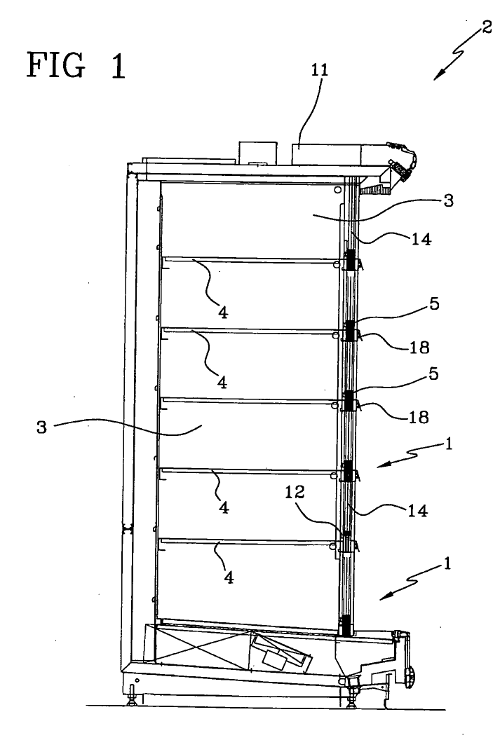

FIG. 1 shows a lateral section view of a refrigerating cabinet comprising a closing system in accordance with the present invention, in a first open operative position;

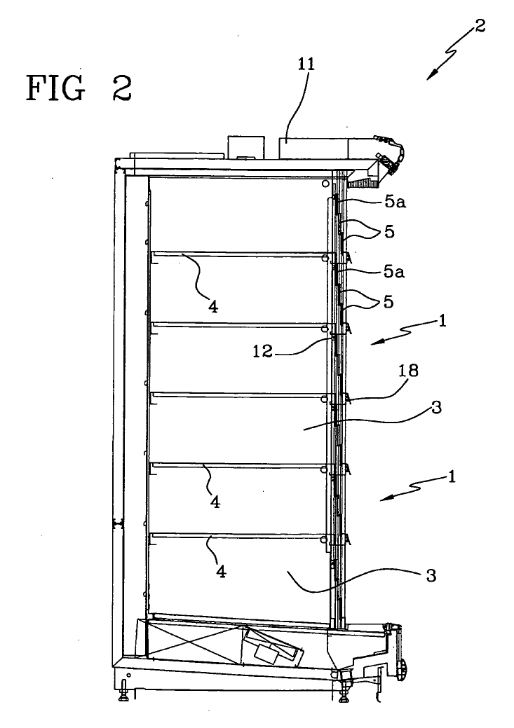

FIG. 2 shows a lateral section view of a refrigerating cabinet comprising a closing system in accordance with the present invention, in a second closed operative position;

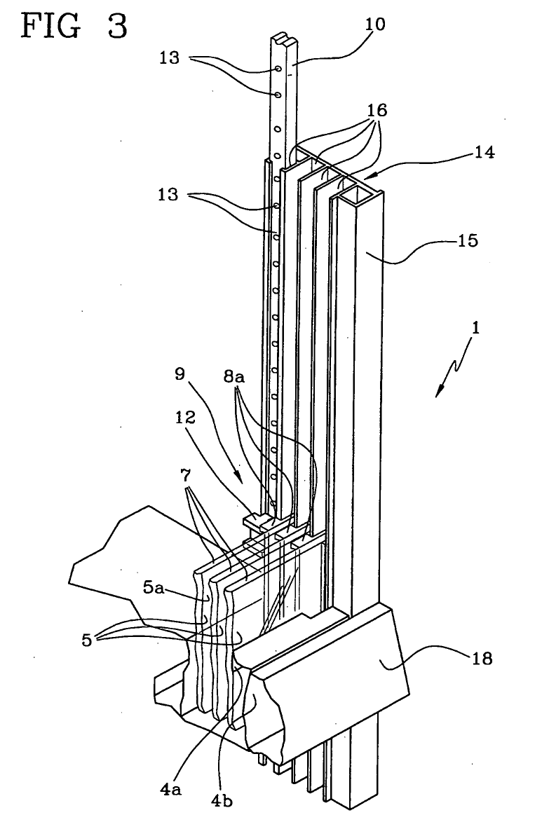

FIG. 3 shows a perspective, partially sectioned view of the closing system of the present invention, in a first open position;

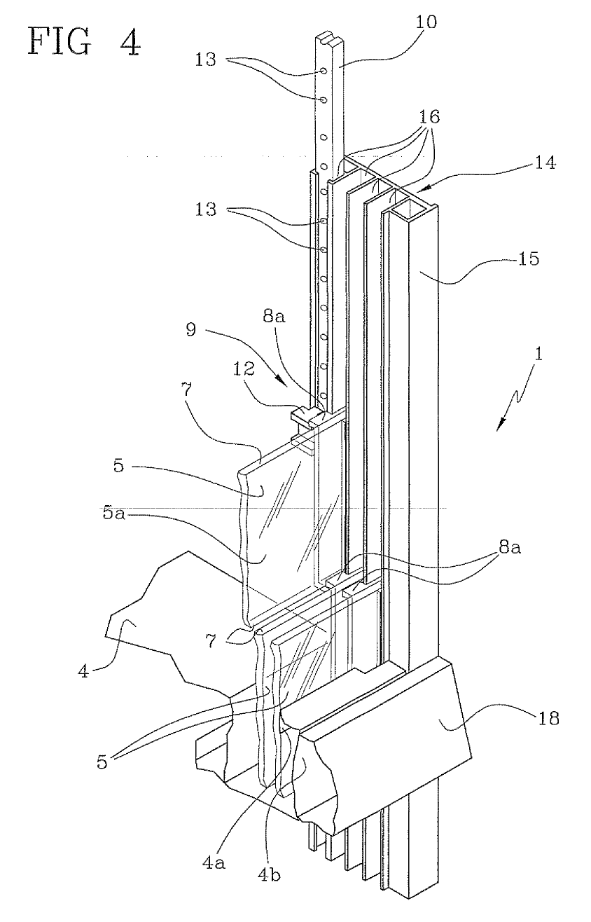

FIG. 4 shows a perspective, partially sectioned view of the closing system of the present invention, in an intermediate position between open and closed;

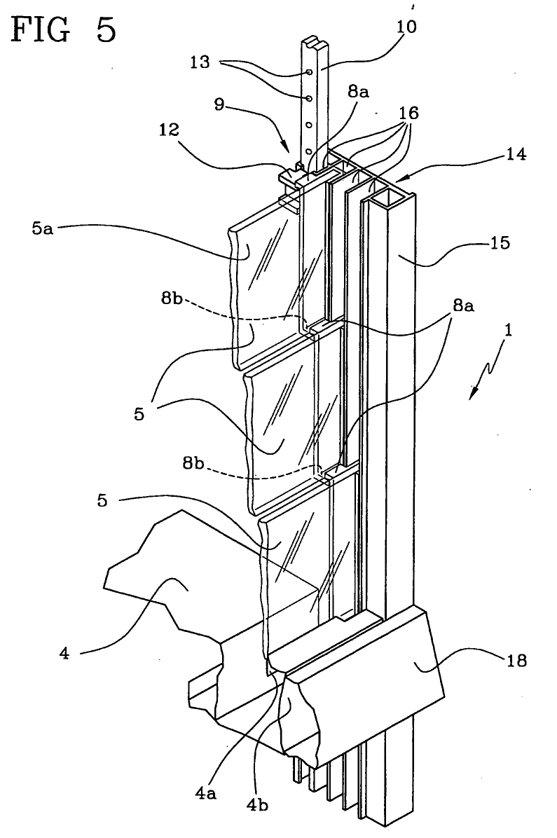

FIG. 5 shows a perspective, partially sectioned view of the closing system of the present invention, in a first closed position;

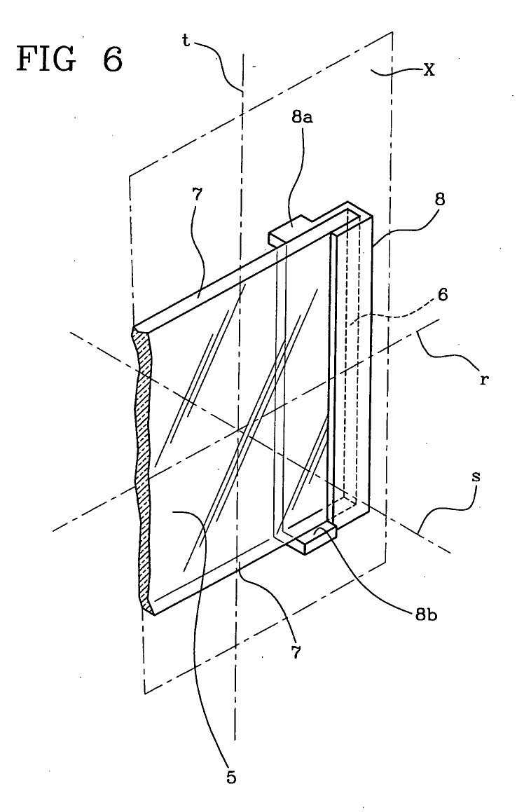

FIG. 6 shows a perspective, partially sectioned view of a detail of a component of the closing system of the present invention;

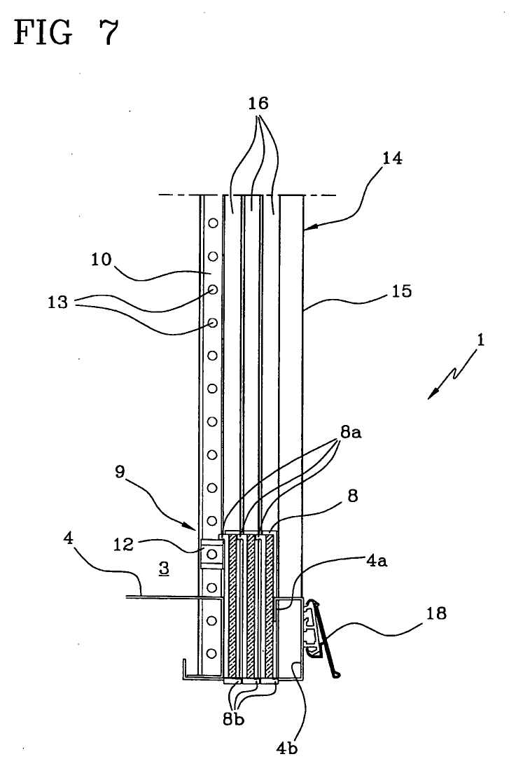

FIG. 7 shows a lateral view of the closing system of the present invention, in open position;

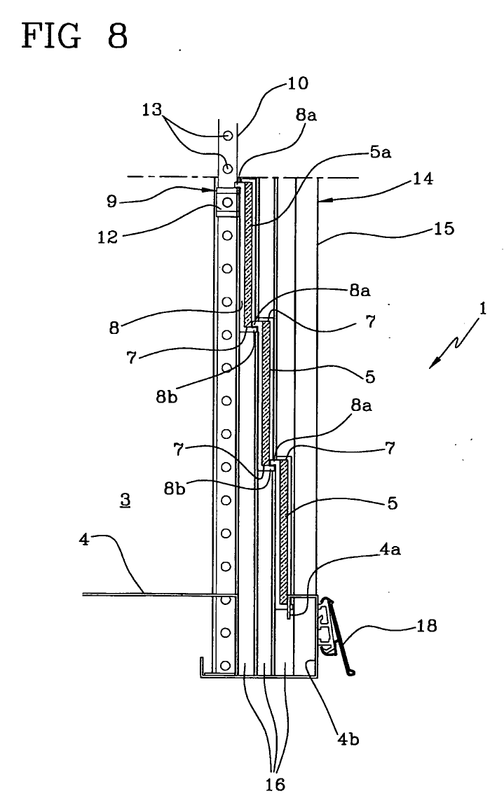

FIG. 8 shows a lateral view of the closing system of the present invention in closed position;

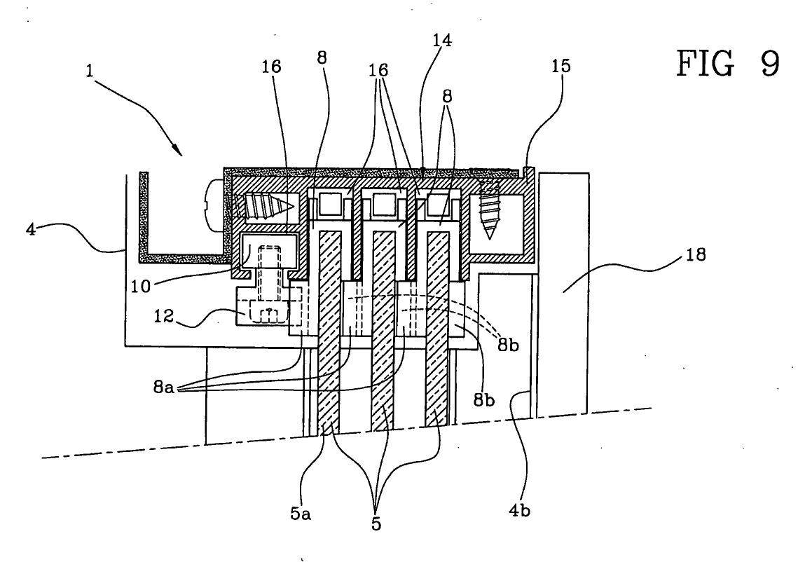

FIG. 9 shows a sectioned plan view of a detail of the closing system of the present invention;

With reference to the accompanying figures, the number 1 indicates, in its entirety, a closing system for refrigerating cabinets 2 in accordance with the present invention.

The refrigerating cabinets 2 comprise a plurality of compartments 3 for the containment of food products to be sold.

The closing system 1 of the present invention comprises a plurality of panels 5 mutually connected telescopically and slidable between an open position, whereat the panels 5 are mutually compacted, completely superposed, facing each other and aligned along an orthogonal direction s to a plane X of lay of the panels, and a closed position, whereat the panels are arranged along a direction t parallel to the plane X of lay of the panels, offset along an orthogonal direction to said plane X and possibly partially superposed.

The panels are actuated by means of a traction device 9, active on a first driving panel 5a that drives the other panels 5 in the translation movement.

The panels 5 have preferably quadrilateral shape and they comprise two opposite first sliding sides 6, parallel to the direction along which the panels translate, and two second sides 7 of connection between the panels, whereat, during the closing phase, two adjacent panels are engaged. Advantageously, the panels are in a variable number between two and five, preferably three, depending on the amplitude of the compartment to be closed.

Each panel 5 is framed in a profile 8 which, preferably, delimits each of the first two sliding sides of the panels 5 and at least partially the second two connecting sides 7 between the panels 5.

Said profile 8 could be, in particular embodiments, an integral part of the panel 5, which thus could be shaped according to a non-planar geometry. Hereafter, nonetheless, reference shall be made to the solution described above, of a profile 8 separate from the panel 5.

The profile 8 has, in lateral section, an “S” shape, i.e. it comprises at least a first 8a and a second 8b projection, each positioned at one of the second sides 7 of the related panel 5. The first 8a and the second 8b projection are orthogonal to the plane X of lay of the respective panel 5, oriented in opposite direction relative to said plane X.

Therefore, the first 8a projection of the profile 8 of each panel 5 is coupled by interference with the second projection 8b of the profile 8 of the adjacent panel 5 and vice versa; in this the translation is transmitted from the driving panel 5a to the other panels 5 comprising the closing system 1.

The first projection 8a of the driving panel 5a engages the traction device 9, as explained hereafter, whilst the second projection 8b of the last panel 5 abuts against an abutment element 4a of the front part 4b of the shelf 4. The traction device 9 comprises at least one driving bar 10 parallel to the side 6 of sliding of the panels 5 and preferably driven by a motor 11 positioned above or within the refrigerating cabinet 2. Moreover, the traction device 9 comprises an abutment block 12, fastened in adjustable position to the driving bar 10, which interferes with the first driving panel 5a dragging it with itself in the translation.

Aligned axially along the longitudinal development of the driving bar 10, a plurality of holes 13 are provided, whereat can be fastened the abutment block 12; the coupling position of each abutment block 12 depends on the distance between the two walls delimiting each containment compartment 3 along the direction of translation of the panels 5.

As shown in FIGS. 3-5, the closing system 1 further comprises at least one supporting and guiding element 14 for the panels 5, operatively connected to at least one of the sliding sides of the panels 5. Preferably, two supporting and guiding elements 14 are present, one for each first sliding side 6 of the panel 5.

As is better shown in FIG. 9, the supporting and guiding element 14 comprises a section bar 15 comprising a plurality of sliding seats 16, each able to contain the traction device 9 and the first sliding sides 6 of each panel 5 with the respective profiles 8.

As shown in FIG. 9, inside the sliding seats 16 able to house the panels 5 are present elements 19 whose purpose is either to facilitate the sliding of the panels and prevent the side skidding or the flexing of the panel, in which case they are rollers positioned with their axis of rotation orthogonal to the plane X of the panel, or they are centring elements that fill the part of the seat 16 exceeding beyond the size of the panel 5, preventing the panel 5 itself from moving transversely to the direction of sliding or to have excessive play within the seat 16. Advantageously, the better to balance and support the weight of the panels 5, there are two traction devices 9, both active on the same driving panel 5a and each associated to a respective supporting and guiding element 14.

The accompanying FIGS. 1 and 2 show examples of vertical refrigerating cabinets. In this configuration, the panels 5 slide on vertical planes, in vertical direction, i.e. in the direction of the height of the cabinet 2; in the case of semi-vertical cabinets, where the ideal plane that separates the refrigerated volume from the outside environment is not orthogonal to the floor but inclined (because for example the shelves 4 that delimit the compartments 3 have progressively decreasing from the base to the top of the cabinet), the panels 5 slide on oblique planes, inclined relative to the horizontal, i.e. relative to the plane of bearing of the cabinet itself.

FIGS. 3, 4 and 5 show the preferred configuration of the closing system 1 with panels able to slide on a vertical plane. In particular, these figures show three different phases of actuation of the panels 5 which slide in the vertical direction to open or close access to the compartment 3 containing the products: FIG. 3 shows the open position of the compartment 3, FIG. 5 the closed position and FIG. 4 an intermediate position.

The closing system 1 of the present invention can be coupled individually to each compartment 3 constituting the refrigerating cabinet 2, to close, in reversible fashion, access to the products contained within and to minimise thermal dispersion to the environment. Therefore, each individual product containment compartment 3 is closed by a respective closing system 1, and in particular by a group of panels 5 that slide, translating relative to each other on parallel planes, to move from an open position in which they are mutually superposed and stacked, as shown in FIGS. 3 and 7, to a closed position, as shown in FIGS. 5 and 8, in which they are positioned offset relative to each other, with the second connection sides 7 matching or partially superposed, thereby preventing access to the compartment 3.

The system also comprises a control device, not shown, able to control the opening of the panels 5. In particular, said control device can comprise, for example, position or volumetric sensors that detect the presence of a user, communicate the information to a central unit which in turn activates the motor 11 that actuates the traction bar 10 and hence, through the abutment block 12, causes the opening or the closing of the panels 5. The system is thus easily automated, e.g. with the simultaneous opening of the shelves of an entire cabinet or of a portion thereof at pre-determined times or when customers enter the isle or when a customer approaches the cabinet, as described above. Similar automatic mechanisms can be provided for the closing phase.

Alternatively, the control device can also be manual and operated directly by the user.

Both in the case of manual activation and of automated activation, the abutment block 12 interferes with the first projection 8a of the profile 8 of the driving panel 5a. In particular, in the specific case of a closing system 1 applied to vertical refrigerating cabinets 2, the first projection 8a interferes with the abutment block 12 which, rising (FIG. 3-5), drives and accompanies the driving panel 5a upwards, until reaching the overlying shelf or the closing roof of the cabinet, with reference to the top compartment 3. The panels 5 are in turn driven as a result of the mutual interference between the projections 8a and 8b of the profiles 8 of each panel 5.

Vice versa, in the opening phase, the driving bar 10 causes the downwards translation of the abutment block 12, which therefore accompanies the driving panel 5a and hence the remaining panels 5 downwards, thrust by their own weight and guided by the elements 14, until making all the panels bear on the front part 4b of the shelf 4 of the individual compartment 3.

The system of the present invention therefore opens the compartment 3 compacting downwards the panels 5 which, descending, assume the open position (FIGS. 3 and 7).

In this position, the panels 5 can be considered out of the customer's sight. One portion, in fact, is actually hidden behind the front part 4b of the shelf 4 of each compartment 3, e.g. behind the price-holding element 18.

The theoretically visible portion of the panels, instead, is not considered a closure, because it serves as a product-holder because it is sufficiently low that it does not hide the products but sufficiently high to prevent the product from the sliding down from the shelf, which generally is slightly inclined downwards.

Preferably, the closing systems 1 of a same row of containment compartments are activated simultaneously. Alternatively, a plurality of driving bars 10 can be provided, mutually uncoupled, and activated individually by an electric motor.

The panels 5 are made of transparent material, e.g. plastic, glass or methacrylate, in order constantly to assure the visibility of the products arranged on the shelves. Moreover, the closing system 1 is not airtight, so that there is a constant recirculation of air that prevents the panel from fogging over with the consequent temporary inhibition of the visibility of the products.

The described closing system is modular, i.e. it can be applied on all the shelves or exhibition counters of refrigerating cabinets with vertical development or with horizontal development and it can be adapted to the different dimensions and heights of the compartments containing the products. The holes present on the driving bar 10 enable to determine the travel of the panels according to the height separation between two consecutive shelves. Therefore, said closing system is compatible with the need to change the height position of the shelves, typical for the type of display cases described. Once the shelves are positioned at the desired height, it is sufficient to adjust the height of the various traction devices, and specifically the abutment blocks, so that in the open position the panels reach a correct height, without interfering with the overlying shelf for ceiling); for the lower end stop, instead, no adjustment is necessary, because the panels stop in any case by gravity on the front part of the shelf, regardless of the actual maximum travel of the traction device.

Since the movements of the driving panel are relatively limited, in the order of a few centimetres, the system goes from the open position to the closed position in a short time, in the order of seconds, making it possible to automate the system.

The described closing system therefore combines the advantages of day-time closing systems with the advantages of night-time closing systems, allowing good visibility and ease of access to the products, whilst limiting energy consumption since each compartment is closed individually, both when the store is closed and, above all, when the store is open.

1. A closing system for refrigerating cabinets, characterised in that it comprises:
a plurality of panels (5) mutually connected telescopically and slidable between an open position, whereat the panels (5) are completely superposed, facing each other and aligned along an orthogonal direction (s) to a plane (X) of lay of the panels (5), and a closed position, whereat the panels are arranged along a direction (t) parallel to the plane (X) of lay of the panels, offset along an orthogonal direction to said plane (X);
at least one element (14) for supporting and guiding said panels (5);
at least one traction device (9) of the panels, able to actuate said panels (5);
said closing system (1) being able to be coupled to each refrigerated compartment (3) containing the refrigerating cabinet (2), to close, in reversible fashion, access to the products contained within the compartment (3).

2. System as claimed in claim 1, characterised in that said panels (5) are transparent.

3. System as claimed in one of the previous claims, characterised in that the panels (5), in an open position, are partially hidden behind a front part (18) of a containment compartment (3), such as to freely allow access to the compartment (3) and simultaneously to prevent the products from falling from the cabinet.

4. System as claimed in one of the previous claims, characterised in that said panels (5) comprise a first driving panel (5a), operatively connected to the traction device (9).

5. System as claimed in one of the previous claims, characterised in that each panel (5) is framed in a profile (8) having at least a first (8a) and a second (8b) projection, oriented orthogonally relative to said plane (X) facing mutually opposite directions; said first (8a) and said second (8b) projection of the profile (8) of at least one panel (5) being engageable by contrast respectively with the second (8b) and with the first (8a) projection of the profile (8) of an adjacent panel (5), to transmit the translation movement to said adjacent panel (5).

6. System as claimed in one of the previous claims, characterised in that each panel (5) comprises at least a first (8a) and a second (8b) projection, oriented orthogonally relative to said plane (X) facing mutually opposite directions; said first (8a) and said second (8b) projection of at least one panel (5) being engageable by contrast bar (10), to adjust the attachment position of the abutment block (12).

16. System as claimed in one of the previous claims, characterised in that it comprises two traction devices (9), each associated, in mutually opposite position, to a respective first sliding side (6) of a first driving panel (5a), operatively connected with the traction device (9).

17. System as claimed in one of the claim 5 or 7, characterised in that at least two first opposite sliding sides (6) of each panel (5) and at least partially two second connecting sides (7) between the panels (5) are covered by said profile (8) provided with projections (8a, 8b); said profile (8) sliding within the sliding seats (16) of the supporting and guiding element (14).

18. System as claimed in one of the previous claims, characterised in that said panels (5) slide along a vertical plane.

19. System as claimed in one of the previous claims, characterised in that said panels (5) slide along an oblique plane.

20. System as claimed in one of the previous claims, characterised in that it comprises at least one control device able to control the opening of said system (1).

21. Refrigerating cabinet comprising a plurality of compartments (3) for the containment of food products, characterised in that it comprises, associated to each containment compartment (3), a closing system (1) as claimed in one or more of the claims 1 through 20.

22. A refrigerating cabinet as claimed in claim 21, characterised in that the closing systems (1) associated to the individual containment compartments (3) are activated simultaneously.

23. A refrigerating cabinet as claimed in claim 21 or 22, characterised in that the closing systems (1) associated to the individual containment compartments (3) are activated individually.
